(19) United States
(12) Patent Application Publication
(10) Pub. No.: US 2020/0196631 A1
(43) Pub. Date: Jun. 25, 2020

(54) ANIMAL FEED CONTAINING BLACK SOLDIER FLY LARVAE

(71) Applicant: EnviroFlight, LLC, Irving, TX (US)

(72) Inventors: Elizabeth Allison KOUTSOS, Apex, NC (US); Carrie Ann KUBALL, New Richmond, WI (US)

(73) Assignee: INTREXON CORPORATION, Blacksburg, VA (US)

(21) Appl. No.: 16/715,405

(22) Filed: Dec. 16, 2019

Related U.S. Application Data
(60) Provisional application No. 62/781,982, filed on Dec. 19, 2018.

(51) Int. Cl. A23K 10/20; A23K 10/30; A23K 40/10; A23K 50/75; A23K 20/24; A23K 20/26; A23K 20/142; A23K 20/174; A23K 10/18

(52) U.S. Cl. CPC A23K 10/20; A23K 10/30; A23K 40/10; A23K 50/75; A23K 10/18; A23K 20/26; A23K 20/142; A23K 20/174; A23K 20/24

(57) ABSTRACT

A nutritional composition is provided that does not contain soy and contains black soldier fly larvae as the principle protein source. In further embodiments, the described nutritional composition further comprises whole and/or split legume(s), whole seed(s), and optionally dried vegetable(s). In another aspect, a method for feeding a poultry animal is provided, and comprises feeding the described poultry feed composition to the poultry animal.

### CROSS-REFERENCE TO RELATED APPLICATIONS

This application claims benefit of U.S. Provisional Application No. 62/781,982, filed Dec. 19, 2018, which is incorporated by reference herein in its entirety.

### FIELD OF THE INVENTION

Provided is an animal feed, and more particularly, a poultry feed that uses black soldier fly larvae (BSFL) as the primary protein source. Further provided are various animal feed compositions comprising BSFL.

### BACKGROUND OF THE INVENTION

Insects are rich sources of proteins, good fats, and certain trace elements and vitamins. Their greatest advantage over other animal meats, which underlies their frequent championing as saviors in a food-insecure world, is their lower environmental impact. Insects have a lower feed to-protein conversion ratio than cattle or swine and even poultry according to some sources, and produce fewer greenhouse gases and lower ammonia emissions than any conventional livestock. Industrial-scale insect farms need less water and land space than pasture, can have a lower water footprint per gram of protein than any conventional livestock or even milk and eggs, and some insect species can even consume organic waste and side-streams. Thus insect rearing can operate in developing countries that need low-tech and low-capital investment, yet can still be done with high technology and automated methods to produce consistent, safe, high-quality products. Insects can also improve the environmental footprint of vertebrate meats indirectly, through their use as feed. Rearing insects on human-inedible wastes and feeding them to larger food animals (whose wastes can even be fed to the insects in a partly closed circle of food energy) can boost the protein content of these animals and is more environmentally friendly and efficient than growing fields of grains or other feeds, which use land and resources that could otherwise be used to grow food for humans.

One known problem with industrializing edible insects today, however, is the relative dearth of insects to choose from. While thousands of species are consumed worldwide, all but a dozen or so are wild caught by more traditional societies and cannot at this time be farmed, with consequences for regular supply and for conservation. The species commonly sold and consumed in the West, such as house crickets and mealworms, are thus not necessarily the most sustainable species nor those with the most desirable organoleptic properties such as taste and texture. Insects that are difficult to rear or harvest and thus in lower supply would also be more expensive, lowering their desirability among most consumers; and of course the issue of flavor in food acceptance cannot be understated. Rearing insects on otherwise inedible organic wastes would greatly lower their environmental footprint and boost their utility, in particular for developing world consumers. An added benefit is the recycling of the waste itself, as the management of organic wastes such as manure, leachates, and food waste is both costly and a growing environmental concern. Rearing edible insects on wastes would solve two problems at once, but popular species like cricket and mealworm cannot be reared easily on most waste, especially animal products. A need exists, therefore, to identify and refocus attention on species with superior cultivation properties than extant edible insect species, but which can still be used either as feed or food.

The black soldier fly, Hermetia illucens, is a true fly (Diptera) of the family Stratiomyidae. Though originally native to the Americas, it now occurs worldwide in tropical and temperate regions, and its lack of hardiness to the cold precludes its invasion of nonnative regions such as Northern Europe. Adults consume nothing but water, do not bite or sting, and do not vector or disseminate any specific diseases. Black soldier fly larvae (BSFL) are reported as feeding on an immense variety of organic material, and have already been used in small-scale waste management purposes using substrates such as manure, rice straw, food waste, distillers' grains, fecal sludge, animal offal, kitchen waste, and so on. The diversity of substrates they can process and the efficiency with which they do so may be the highest among the flies. BSFL are also edible, and have been studied as such. Their feed conversion ratios are known to be superior to both crickets and mealworms, and, compared to those two, BSFL survival rate and nitrogen and phosphorus compositions do not vary as highly with diet. BSFL accumulate lipids from their diet for use as energy by the non-feeding adult, to the point that they can be converted to biodiesel. What they do not consume, combined with their nitrogen-rich frass, can be used as fertilizer. Their larval development time of over three weeks is longer than that of flies such as house and carrion flies (<5 days), meaning a single larva will consume a larger amount of substrate and produce larger pupae. Additionally, when BSFL are at the pre-pupa stage, they will instinctively leave the substrate and move to a high, clean place, a behavior called “selfharvesting” that removes an otherwise labor-intensive step from their farming. All these benefits make BSFL practical to rear and a suitable tool to valorize wastes, plus possibly a sustainable human food source, as well as animal feed, and in particular, livestock feed, as described in detail below.

BSFL meal and oil are already considered to be an animal-grade alternative to fish meal and fish oil used to feed carnivorous fish and in other animal diets, due to their high protein and lipid contents even when fed plant-based waste streams. The importance of fish meal and oil in aquaculture is well known, but competition with demands for fish for human consumption and depleted fisheries, among other factors, have brought the supplies of fish meal and oil down and costs up, leading fisheries to search for alternatives such as vegetable oils. BSFL can accumulate lipids in their bodies if fed an appropriately lipid-rich diet, and are generally more palatable to the fish than vegetable oils. Omega-3 fatty-acid-enhanced BSFL are produced when the larval diet is supplemented with fish offal. Such “enriched” BSFL are suitable fish foods, producing no significant differences in fish growth and vision development when compared to normal fish meal for feeding the rainbow trout, Oncorhynchus mykiss. Ultimately BSFL's ability to efficiently produce protein-rich edible biomass from potentially protein-poor organic wastes has led many authors to conclude that BSFL can contribute meaningfully to sustainable aquaculture as partial or total meal replacement, including for aquatic invertebrates such as shrimp.

When defatted, BSFL meal can have crude protein levels over 60%, comparable to other insect meals, and will have lower lipid percentages, assuaging concerns over the saturated fat content. The micronutrient profiles also depend on the substrate fed. BSFL accumulate calcium (the most abundant mineral in BSFL) and manganese, but do not accumulate sodium or sulfur. BSFL meal can have over one order of magnitude more calcium than most other insects (6.6%-9.3% by dry weight compared to less than 1% for other insects) and more than fish meal, providing a considerable advantage to BSFL over other insects nutritionally. They also provide adequate levels of other essential minerals and vitamins at a level equivalent or superior to other insects. A nutraceutical benefit was also reported, in that BSFL are rich in C12:0 medium-chain fatty acids, which has demonstrated prebiotic effects on the microbiota of livestock and antibiotic effects on gastrointestinal disease-causing bacteria.

Therefore, the use of BSFL as a livestock feed, and in particular, a poultry feed, was investigated.

### BRIEF SUMMARY OF THE INVENTION

In one aspect, a nutrient composition is provided and comprises black soldier fly larvae (BSFL), whole and/or split legume(s), seed(s), including whole seeds, and optionally, vegetable(s), preferably dried vegetables, and does not contain soy. In various embodiments, the BSFL is whole or defatted. In various embodiments, the BSFL is provided as a meal, which comprises ground BSFL, which may be partially or fully defatted. In various embodiments, the BSFL or BSFL meal is partially defatted, substantially defatted, or fully defatted. In various embodiments, the BSFL, either whole or as meal, is the primary protein source.

In one embodiment, the nutrient composition contains BSFL at least 15% by weight of the composition, whole and/or split legume(s) at between 2% and 10% by weight of the composition, whole seed(s) at between 2% and 10% by weight of the composition, and if present, dried vegetable(s) at up to 5% by weight of the composition. The BSFL is whole or as meal and can be defatted. In one embodiment, the whole and/or split legume is split peas. In one embodiment, the seed is sunflower. In one embodiment, the seed is sunflower seed grey stripe with hull. In one embodiment, the seed is whole seed. In one embodiment, the dried vegetable is spinach and/or carrots.

In a further embodiment, the nutrient composition further comprises at least one additional ingredient selected from the group consisting of barley, flaxseed, canola meal, and algae meal. In one embodiment, the nutrient composition contains, when present, barley at 10% to 17% by weight of the composition, flaxseed at 2% to 10% by weight of the composition, canola meal at 0.5% to 5% by weight of the composition, and algae meal at 0.25% to 2% by weight of the composition.

In yet another embodiment, the nutrient composition further comprises at least one additional ingredient selected from the group consisting of whole wheat, corn, calcium carbonate, dicalcium phosphate, brewer's yeast, salt, marigold extract, calcium propionate, probiotic, vitamin/mineral mixture, DL methionine, and L lysine. In one embodiment, the salt is sodium chloride. In one embodiment, the probiotic contains any or all of the following organisms: Lactobacillus spp., Bifidobacterium spp., Enterococcus spp. In one embodiment, the vitamin/mineral mixture comprises vitamin and mineral sources in appropriate levels to provide a balanced vitamin and mineral content of the finished product to meet or exceed known nutrient requirements of poultry. In one embodiment, the nutrient composition contains, when present, whole wheat at 10% to 17% by weight of the composition, corn at 10% to 17% by weight of the composition, calcium carbonate at 2% to 10% by weight of the composition, dicalcium phosphate at 2% to 10% by weight of the composition, brewer's yeast at 0.5% to 5% by weight of the composition, salt at 0.25% to 2% by weight of the composition, marigold extract at 0.25% to 2% by weight of the composition, calcium propionate at 0.25% to 5% by weight of the composition, probiotic at 0.1% to 0.5% by weight of the composition, vitamin/mineral mixture at 0.1% to 0.5% by weight of the composition, DL methionine at up to 0.25% by weight of the composition, and L lysine at up to 0.2% by weight of the composition.

In one embodiment, the nutrient composition has at least one of the following nutrient requirements: crude protein—minimum of 16% by weight of the composition; crude fat—minimum of 3% by weight of the composition; crude fiber—maximum of 8% by weight of the composition; calcium—3.5% to 4.5% by weight of the composition; phosphorous—maximum of 1% by weight of the composition; salt—0.6% to 1.0% by weight of the composition; lysine—minimum of 0.7% by weight of the composition; and methionine—minimum of 0.35% by weight of the composition.

In one embodiment, the nutrient composition is in the form of a blend comprising a pellet/crumble component and a coarse component. In one embodiment, the BSFL is in the pellet/crumble component, the whole and/or split legume(s) and the seed(s) (e.g., whole seed(s)) are in the coarse component, and the dried vegetable(s), if present, is in either the pellet/crumble component or the coarse component. In one embodiment, if present, the barley and flaxseed are in either the pellet/crumble component or the coarse component, and the canola meal and algae meal are in the pellet/crumble component. In one embodiment, if present, the whole wheat, corn, and calcium carbonate are in either the pellet/crumble component or the coarse component, and the dicalcium phosphate, brewer's yeast, salt, marigold extract, calcium propionate, probiotic, vitamin/mineral mixture, DL methionine, and L lysine are in the pellet/crumble component.

In another aspect, a method for feeding an animal is provided, where the method comprises providing the described nutrient composition to the animal. In one embodiment, the animal is a poultry animal, such as but not limited to a chicken or other granivorous avian species such as game birds and psittacines.

### DETAILED DESCRIPTION OF THE INVENTION

In one aspect, a nutrient composition is provided, which uses black soldier fly larvae (BSFL) as the primary protein source. In embodiments in which the nutrient composition is for poultry, it differs from traditional poultry diets, as it does not contain soy. In various embodiments, the BSFL consists of dried whole larvae or meal, and optionally, is partially, substantially, or fully defatted. The defatted BSFL provides a higher protein content with lower fat content. In various embodiments, the BSFL, either whole or as meal, is the primary protein source. In one example, the defatting procedure consists of heating the larvae, pressing the fat out manually and then grinding the resulting “cake” into a meal form.

In one embodiment, the nutrient composition has no soy and comprises BSFL, whole and/or split legume(s), seed(s) (e.g., whole seed(s)), and optionally, dried vegetable(s). The BSFL is whole or as meal and can be defatted. In one embodiment, the whole and/or split legume is peas. In one embodiment, the whole and/or split legume is split peas. In one embodiment, the seed is sunflower (e.g., whole sunflower seeds). In one embodiment, the whole seed is sunflower seed grey stripe with hull. In one embodiment, the dried vegetable is spinach and/or carrots. In various embodiments, the nutrient composition contains greater than about 15% by weight of BSFL, about 2% to about 10% by weight whole and/or split legume(s), about 2% to about 10% whole seed(s), and 0% to about 5% dried vegetable(s).

In various embodiments, the nutrient composition further comprises at least one of barley, flaxseed, canola meal, and algae meal. In these various embodiments, when present, the nutrient composition contains about 10% to about 17% by weight barley, about 2% to about 10% by weight flaxseed, about 0.5% to about 5% by weight canola meal, and about 0.25% to about 2% by weight algae meal.

In further additional embodiments, the nutrient composition further comprises at least one of whole wheat, corn, calcium carbonate (fine), dicalcium phosphate, brewer's yeast, salt, such as sodium chloride, marigold extract, calcium propionate, probiotic, vitamin/mineral mixture, DL methionine, and L lysine. In one embodiment, the probiotic contains any or all of the following organisms: Lactobacillus spp., Bifidobacterium spp., Enterococcus spp. In one embodiment, the vitamin/mineral mixture comprises vitamin and mineral sources in appropriate levels to provide a balanced vitamin and mineral content of the finished product to meet or exceed known nutrient requirements of poultry. In these further embodiments, when present, the nutrient composition contains about 10% to about 17% by weight whole wheat, about 10% to about 17% by weight corn, about 2% to about 10% by weight calcium carbonate (fine), about 2% to about 10% by weight dicalcium phosphate, about 0.5% to about 5% brewer's yeast, about 0.25% to about 2% by weight salt, such as sodium chloride, about 0.25% to about 2% by weight marigold extract, about 0.25% to about 5% by weight calcium propionate, about 0.1% to about 0.5% by weight probiotic, about 0.1% to about 0.5% vitamin/mineral mixture, optionally about 0% to about 0.25% by weight DL methionine, and optionally 0% to about 0.2% by weight L lysine.

In one embodiment, the nutrient composition has no soy and comprises defatted BSFL meal, split peas, sunflower seed grey stripe with hull, and optionally, dried spinach. In another embodiment, the nutrient composition comprises defatted BSFL meal, split peas, sunflower seed grey stripe with hull, barley, flaxseed, canola meal, algae meal, and optionally dried spinach. In another embodiment, the poultry feed comprises defatted BSFL meal, split peas, sunflower seed grey stripe with hull, barley, flaxseed, canola meal, algae meal, whole wheat, corn, calcium carbonate (fine), dicalcium phosphate, brewer's yeast, salt, such as sodium chloride, marigold extract, calcium propionate, probiotic, vitamin/mineral mixture, optionally dried spinach, optionally DL methionine, and optionally L lysine.

In various embodiments, the nutrient composition contains ingredients that provide optimal pigmentation, such as algae, spinach, corn gluten meal, and/or marigold extract. In various embodiments, the nutrient composition contains ingredients that provide nutrient supplementation to promote optimal egg nutrition, such as omega-3 fatty acids, vitamin E, and/or carotenoids. The described nutrient composition differs from commercial poultry diets by being formulated without most commodity ingredients.

In another embodiment, the nutrient composition is described by its nutrient content. In one embodiment, the poultry feed has the following nutrient profile, including the described ranges:

| Nutrient Name | | |
|---|---|---|
| Units | Minimum | Maximum |
| Crude Protein % | 16 | 19 |
| Crude fat % | 3 | 7 |
| Ash % | 0 | 18 |
| Crude Fiber % | 0 | 8 |
| Ca % | 3 | 4.5 |
| P % | 0.5 | 1 |
| Mg % | 0.15 | |
| K % | 0.15 | |
| Na % | 0.25 | 0.4 |
| Cl % | 0.13 | 0.45 |
| S % | | |
| Fe ppm | 75 | 450 |
| Zn ppm | 60 | 175 |
| Mn ppm | 60 | 150 |
| Cu ppm | 10 | 40 |
| I ppm | 0.04 | |
| Se ppm | 0.30 | 1.00 |
| Vit A Retinol IU/kg | 7,500.00 | 10,000.00 |
| Vit D3 IU/kg | 2,200.00 | 4,500.00 |
| Vit E IU/kg | 44 | 100 |
| Vit K IU/kg | 0.5 | 1.5 |
| xanthophylls ppm | 40 | |
| Thiamin ppm | 3 | |
| Biotin ppm | 0.2 | |
| Riboflavin ppm | 5 | |
| Niacin ppm | 20 | |
| Panthethenate ppm | 5 | |
| Pyridoxine ppm | 5 | |
| Folate ppm | 5 | |
| Vit B12 ug/kg | 5 | |
| Choline ppm | 1,500.00 | 3,000.00 |
| Arg % | 0.7 | |
| His % | 0.2 | |
| Ile % | 0.65 | |
| Leu % | 0.85 | |
| Lys % | 0.7 | |
| Met % | 0.35 | |
| Met + Cys % | 0.6 | |
| Phe % | 0.5 | |
| Thr % | 0.5 | |
| Trp % | 0.2 | |
| Val % | 0.8 | |
| Linoleic 18:2n6% | 1.1 | |
| Linolenic 18:2n3% | 0.5 | |

In one embodiment, the nutrient composition has the following nutritional composition:

Crude Protein—minimum of 16%;

Crude Fat—minimum of 3.5%;

Crude Fiber—maximum of 3.5% to 4.5%;

Calcium—3.5% to 4.5%;

Phosphorous—maximum of 1%;

Salt—0.6% to 1.0%;

Lysine—minimum of 0.7%; and

Methionine—minimum of 0.35%.

In various embodiments, the described nutrient composition is provided in a variety of forms, including but not limited to, pellet form, crumble form, which in one embodiment is a pulverized form of the pellets, resulting in the crumble form, and a blend form comprising the pellet/crumble and a coarse mixture. In one embodiment, the pellet form is an extruded composition. The described nutrient composition can also be fashioned into a block.

In various embodiments, the BSFL is present in the pellet/crumble, the whole and/or split legume(s) and whole seed(s) are present in the coarse component of the blend, and if present, the dried vegetable(s) is present in the pellet and/or the coarse. In further embodiments, and if present, the barley and flaxseed are present in the pellet/crumble and/or coarse and the canola meal and algae meal are present in the pellet. In still further embodiments, and if present, the whole wheat, corn, and calcium carbonate (fine) are present in the pellet/crumble and/or coarse, and the dicalcium phosphate, brewer's yeast, salt, such as sodium chloride, marigold extract, calcium propionate, probiotic, vitamin/mineral mixture, DL methionine, and L lysine are present in the pellet.

In one embodiment, the nutrient composition is provided as a blend. In one embodiment, the nutrient composition blend comprises a pellet/crumble composition as described above, in combination with additional ingredients, e.g., coarse mixture. In one embodiment, the nutrient composition blend contains the pellet/crumble composition, barley, whole wheat, calcium carbonate (fine), flaxseed, split peas, and sunflower seed grey stripe with hull. In one embodiment, the nutrient composition blend contains:

| Ingredient | Inclusion % |
|---|---|
| pellet | >40% |
| Barley | 5-15% |
| Whole wheat | 0-10% |
| Calcium carbonate fine | 0-5% |
| Flaxseed | 0-7% |
| Whole and/or split | 0-10% |
| legume(s) | |
| Whole seed(s) | 0-5% |

In one embodiment, the nutrient composition comprises EnviroMeal (black soldier fly meal defatted), whole wheat, ground corn, barley, split peas, calcium carbonate, sunflower seeds, flaxseed, dicalcium phosphate, brewers dried yeast, dried spinach, salt, algae meal, marigold extract, calcium propionate, primalac (probiotic), vitamin and mineral mix, DL-methionine, and choline.

In one embodiment, the nutrient composition in blend form has the following ingredients:

| Ingredient Name | Percent |
|---|---|
| EF defatted BSFL meal | >15 |
| Whole wheat | 10-17 |
| Corn | 10-17 |
| Barley | 10-17 |
| Split peas | 2-10 |
| Calcium carbonate fine | 2-10 |
| Sunflower seed | 2-10 |
| Flaxseed | 2-10 |
| Dicalcium Phosphate | 2-10 |
| Brewers Yeast | 0.5-5 |
| Spinach dried | 0.5-5 |
| Canola Meal | 0.5-5 |
| Salt (NaCl) | 0.25-2 |
| Algae Meal | 0.25-2 |
| Marigold extract | 0.25-2 |
| calcium propionate | 0.25-1.25 |
| Primalac (probiotic) | 0.1-0.5 |
| Vitamin and mineral mix | 0.1-0.5 |
| DL methionine | 0.05-0.25 |

In one embodiment, the nutrient composition in blend form comprises the following pellet/crumble composition:

| Ingredient | Inclusion wt. % |
|---|---|
| defatted BSFL meal | about 30% |
| Whole wheat | about 18% |
| Corn | about 30% |
| Calcium carbonate fine | about 8% |
| Dicalcium Phosphate | about 5% |
| Canola meal | about 1.5% |
| Brewers Yeast | about 1.8% |
| Spinach dried | about 1.8% |
| Salt (NaCl) | about 1% |
| Algae Meal | about 0.8% |
| Marigold extract | about 0.7% |
| calcium propionate | about 0.6% |
| Primalac (probiotic) | about 0.5% |
| Vitamin and mineral mix | as required |
| DL methionine | about 0.3% |
| Choline chloride, 85% | about 0.2% |

In some embodiments, the nutrient composition is for a bird such as a granivorous poultry species or a food bird such as chicken, duck, turkey, goose, guinea fowl, squab, quail, capon, grouse, swan, dove, pheasant, woodcock, snipe, or chukar. In other embodiments the nutrient composition is for a psittacine bird such as a parrot, cockatoo or Strigopoidean species.

The invention also provides a method for feeding an animal comprising providing a sufficient amount of a composition of the invention to the animal to meet its nutritional needs.

What is claimed is:

1. A nutritional composition for animals comprising black soldier fly larvae (BSFL), legume(s), and seed(s).

2. The nutritional composition of claim 1, wherein the composition does not contain soy.

3. The nutritional composition of claim 1, wherein the BSFL comprises at least 15% by weight of the composition, the legume(s) comprise between 2% and 10% by weight of the composition, and the seed(s) comprises between 2% and 10% by weight of the composition.

4. The nutritional composition of claim 1, wherein the BSFL is partially or substantially defatted.

5. The nutritional composition of claim 1, wherein the BSFL is whole or a meal.

6. The nutritional composition of claim 1, wherein the legumes are whole and/or split legumes.

7. The nutritional composition of claim 1, wherein the seeds are sunflower seeds.

8. The nutritional composition of claim 1, further comprising fresh or dried vegetable(s).

9. The nutritional composition of claim 8, wherein the vegetable is spinach and/or carrot.

10. The nutritional composition of claim 1, further comprising at least one additional ingredient selected from barley, flaxseed, canola meal, or algae meal.

11. The nutritional composition of claim 10, wherein, when present, the barley comprises 10% to 17% by weight of the composition, the flaxseed comprises 2% to 10% by weight of the composition, the canola meal comprises 0.5% to 5% by weight of the composition, and the algae meal comprises 0.25% to 2% by weight of the composition.

12. The nutritional composition of claim 1, further comprising at least one additional ingredient selected from whole wheat, corn, calcium carbonate, dicalcium phosphate, brewer's yeast, salt, marigold extract, calcium propionate, probiotic, vitamin/mineral mixture, DL methionine, and L lysine.

13. The nutritional composition of claim 12, wherein, when present, the whole wheat comprises 10% to 17% by weight of the composition, the corn comprises 10% to 17% by weight of the composition, the calcium carbonate comprises 2% to 10% by weight of the composition, the dicalcium phosphate comprises 2% to 10% by weight of the composition, the brewer's yeast comprises 0.5% to 5% by weight of the composition, the salt comprises 0.25% to 2% by weight of the composition, the marigold extract comprises 0.25% to 2% by weight of the composition, the calcium propionate comprises 0.25% to 5% by weight of the composition, the probiotic comprises 0.1% to 0.5% by weight of the composition, the vitamin/mineral mixture comprises 0.1% to 0.5% by weight of the composition, the DL methionine comprises up to 0.25% by weight of the composition, and the L lysine comprises up to 0.2% by weight of the composition.

14. The nutritional composition of claim 1, wherein the composition has at least one of the following nutrient requirements:
crude protein—minimum of 16% by weight of the composition;
crude fat—minimum of 3% by weight of the composition;
crude fiber—maximum of 8% by weight of the composition;
calcium—3.5% to 4.5% by weight of the composition;
phosphorous—maximum of 1% by weight of the composition;
salt—0.6% to 1.0% by weight of the composition;
lysine—minimum of 0.7% by weight of the composition; and
methionine—minimum of 0.35% by weight of the composition.

15. The nutritional composition of claim 1, wherein the composition is in the form of a blend comprising a pellet/crumble component and a coarse component, wherein the BSFL is in the pellet/crumble component, the legume(s) and the seed(s) are in the coarse component, and the vegetable(s), if present, is in either the pellet/crumble component or the coarse component.

16. The nutritional composition of claim 10, wherein, if present, barley and flaxseed are in either the pellet/crumble component or the coarse component, and canola meal and algae meal are in the pellet/crumble component.

17. The nutritional composition of claim 12, wherein, if present, whole wheat, corn, and calcium carbonate are in either the pellet/crumble component or the coarse component, and dicalcium phosphate, brewer's yeast, salt, marigold extract, calcium propionate, probiotic, vitamin/mineral mixture, DL methionine, and L lysine are in the pellet/crumble component.

18. A method for feeding an animal comprising providing the nutritional composition of claim 1 to the animal.

19. The method of claim 18, wherein the animal is a granivorous avian species.

20. The method of claim 18 wherein the animal is a chicken, duck, turkey, goose, guinea fowl, squab, quail, capon, grouse, swan, dove, pheasant, woodcock, snipe, chukar or psittacine bird.
